(19) United States
(12) Patent Application Publication
(10) Pub. No.: US 2008/0210366 A1
(43) Pub. Date: Sep. 4, 2008

(54) Method of making a mat

(75) Inventor: Fu-Chieng Chen, Taipei (TW)

Correspondence Address: TROXELL LAW OFFICE PLLC, SUITE 1404, 5205 LEESBURG PIKE, FALLS CHURCH, VA, 22041, US

(73) Assignee: Formosa Saint Jose Corp.

(21) Appl. No.: 11/713,101

(22) Filed: Mar. 2, 2007

(51) Int. Cl. B29C 65/00

(52) U.S. Cl. 156/182

(57) ABSTRACT

A method of making a mat uses a T-die of an extruder for extruding a molten polymer substance of a cladding material, wherein a transporting device is located below the T-die, and the transporting device is provided with a feeding wheel, which is wound by a roll of cross-linked polyolefin foam (or CLPO foam for abbreviation) or EVA foam to serve as a base material for finishing. The CLPO foam or EVA foam, which serves as the base material for finishing, can be filmed with the cladding material on a single surface or a double-surface. After being filmed with the cladding material, the CLPO foam or EVA foam is rolled into concaved and convex patterns by the knurling wheels, and its temperature is then decreased by the cooling wheels for shaping into the mat which is light in weight, slipper-proof, abrasive-proof, and flexible.

### BACKGROUND OF THE INVENTION

(a) Field of the Invention

The present invention relates to a method of making a mat, and more particularly to a manufacturing method which coats continuously on substrate of foams, such as cross-linked polyolefin foam, EVA foam to make a mat that is light in weight, flexible, and slippery-proof, and which can be applied in making all kinds of mat, including an automobile mat, a household doormat, a sidewalk mat, a bathroom mat, and a Yoga mat.

(b) Description of the Prior Art

A conventional mat sold on a market, including a household doormat, a bathroom mat, and an automobile mat on a floor of the automobile, is paved on a ground for stepping when people are accessing, so as to keep clean for an indoor or in-car floor.

For the mat used in the automobile, conditions of a good mat considered by a manufacturer are:
1. Weight after being manufactured should be light. As all parts of the automobile have almost been considered to be improved to material light in weight, using the light-weight mat can reduce material consumption and save energy consumed when the automobile is moving. Therefore, if the heavy mat materials can be replaced by the light-weight materials, then they will play the greatest role in saving the oil consumed by the automobile.
2. The good mat should have functions such as sound-proof, shock-proof, and leakage-proof. The automobile mat is paved on a floor in the automobile, and serves as a in-car liner after being formed into a three-dimensional shape. The mat is also provided with a function for preventing noise of a chassis at a bottom of the automobile from transmitting to an interior of the automobile, which can enhance a silence effect.
3. After the mat is worn, it can be recycled for reuse, which is provided with an effect of environmental protection, and does not contain harmful volatile ingredients. For a conventional automobile mat, materials thereof can be chosen among a plastic board (a PVC board material), a rubber board, resin, or further with non-woven carpet lamination, etc. These kinds of material have a heavier weight, and for the PVC products, whose compounds contains additives and plasticizers, which should be added in its manufacturing process to achieve required physical properties. However, most of these additives and plasticizers will automatically vaporize gradually to generate harmful elements to human health; therefore, it is definitely undesirable if they are used in the in-car floor mat. On the other hand, for the rubber board, it is provided with a shortcoming that the rubber board cannot be recycled for reusing after hardening process in the manufacturing.

In comparison to a conventional manufacturing method, which includes extruding into rolls of mats, injecting into pieces of mats, or then laminating with different sheet material before assembling, the method of making a mat of the present invention is much efficient, is provided with cheaper manufacturing cost, and enables the product (mat) to be light in weight, abrasive-proof, sound-proof, shock-proof, leak-proof, comfortable upon being stepped by feet, and environmentally benign that it can be recycled to increase its value, thereby being provided with advancement.

### SUMMARY OF THE INVENTION

The primary object of present invention is to provide a method of making a mat, which can quickly, continuously produce the mats with a light-weight, a sound-proof effect, a shock-proof effect, and a leakage-proof effect. In addition, the method can be freely adjusted and changed, to manufacture the thinner or thicker mats with proper thickness, which are also in compliance with an abrasive-proof function, flexibility, and a slippery-proof function.

Another object of the present invention is to provide a method of making a mat, wherein products thereof can be in a roll-shape to be suitable to be paved on a longer sidewalk, or the mats in a roll can be also trimmed to form into automobile mats or household mats that are provided with the flexibility and a slippery-proof function. Accordingly, a method of making a mat, as designed by the present invention, which can be used to manufacture a two-layer or three-layer complex mat, includes a T-die which is in association with an extruder, with a transporting device being located below the T-die, and with a material tank of the T-die being continuously filled with a molten-state polymer substance for making a surface cladding material of the mat from the extruder. This polymer substance is a molten plastic which is extruded out by the extruder, and the transporting device is provided with a plurality of roller elements including a feeding wheel, a first turning idler, a stretching wheel, a second turning idler, a silicon rubber wheel, a knurling wheel, a third turning idler, a first rear-side cooling wheel, a front-side cooling wheel, a second rear-side cooling wheel, a fourth turning idler, and a collecting wheel. A discharge tank of the T-die is located at a slit between the silicon rubber wheel and the knurling wheel, and a roll of cross-linked polyolefin foam (CLPO foam for abbreviation) is wound on the feeding wheel to serve as a base material for finishing. A surface of the CLPO foam is filmed with an upper player cladding material to be assembled, by using homogeneity of chemical bonds of the cladding material under the molten state with olefin chemical bonds of CLPO foam of the base material; and the two substances are assembled into one body by joining between the silicon rubber wheel and the knurling wheel, followed by using the rear-side cooling wheel and the front-side cooling wheel for decreasing temperature and shaping, so as to roll up the formed mats by the collecting wheel. The aforementioned manufacturing process is used to form the films of a single layer. If the upper and lower layers are to be covered with a cladding material of film, then the mat which has been accomplished by the first filming is repeated with the manufacturing process to film with the lower cladding layer; whereas the molten-state thick substance for the single-layer or two-layer cladding material can be chosen among a thermoplastic rubber (or TPR for abbreviation); a thermoplastic elastomer (or TPE for abbreviation); a thermoplastic plastic, such as a high density polyethylene (or HDPE for abbreviation), a low density polyethylene (or LDPE for abbreviation), a linear low density polyethylene (or LLDPE for abbreviation), and a polypropylene (or PP for abbreviation; or all kinds of synthetic resin (ethylene vinyl acetate, or EVA for abbreviation) for coating. The aforementioned cladding materials are all recyclable macromolecular compounds, and the laminated mats after filming can be also recycled into reusable materials.

A wheel surface of the knurling wheel can be carved with concaved grooves and projected bumps; therefore, a surface of the mat is finished to form a lot of longitudinal and transversal grooves that are concaved downward.

On the other hand, the surface of the knurling wheel can be also made into an extremely shallow pattern, finally the mat is heated for softening after being trimmed, and is put into a molding tool to proceed with a joining for shaping. Furthermore, peripheries of the mat are formed with projected and reversely-folded rims, and a center of the mat is provided with a concaved part to form a three-dimensional space, thereby making an automobile mat which is used on an in-car floor.

As the aforementioned molding tool for joining is provided with the concaved grooves and projected bumps on a board body, the surface of the mat can be formed with the plurality of longitudinal and transversal grooves that are concaved downward. On the other hand, ridges are formed on a lower surface of the mat, at places corresponding to the grooves, and closed grooves are formed between the ridges, with peripheries of the grooves being surrounded by the ridges for forming the closed state. Therefore, the mat is flexible due to that the bottom surface thereof is provided with many closed grooves. In the same time, as the material itself is resistant to friction, the mat will not slip freely, and air is exchanged through the closed grooves from pressure exerted when the mat is stepped down, thereby forming an air-permeable effect.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of manufacturing equipment of the present invention.

FIG. 2 shows a side schematic view of manufacturing equipment of the present invention.

FIG. 3 shows an exploded view of a local structure of a first filming with a cladding material of the present invention.

FIG. 4 shows a side schematic view of a manufacturing process of a second filming with a cladding material of the present invention.

FIG. 5 shows an exploded view of a local structure of a second filming with a cladding material of the present invention.

FIG. 6 shows an exploded view of a knurling wheel of the present invention.

FIG. 7 shows a schematic view of an embodiment of the present invention, which is applied in making an automobile mat.

FIG. 8 shows a cutaway view of an embodiment of the present invention, which is applied in making an automobile mat.

### DETAILED DESCRIPTION OF THE PREFERRED EMBODIMENTS

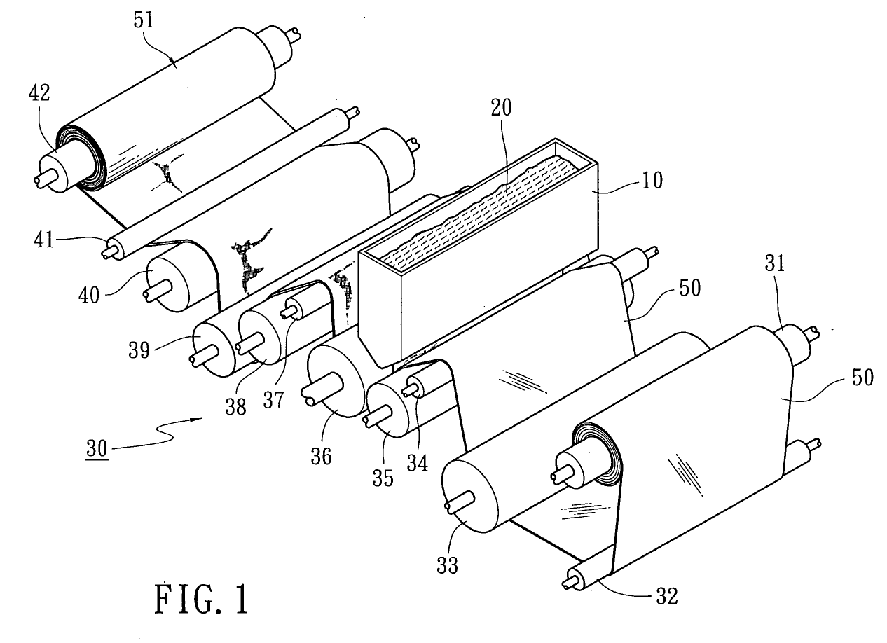

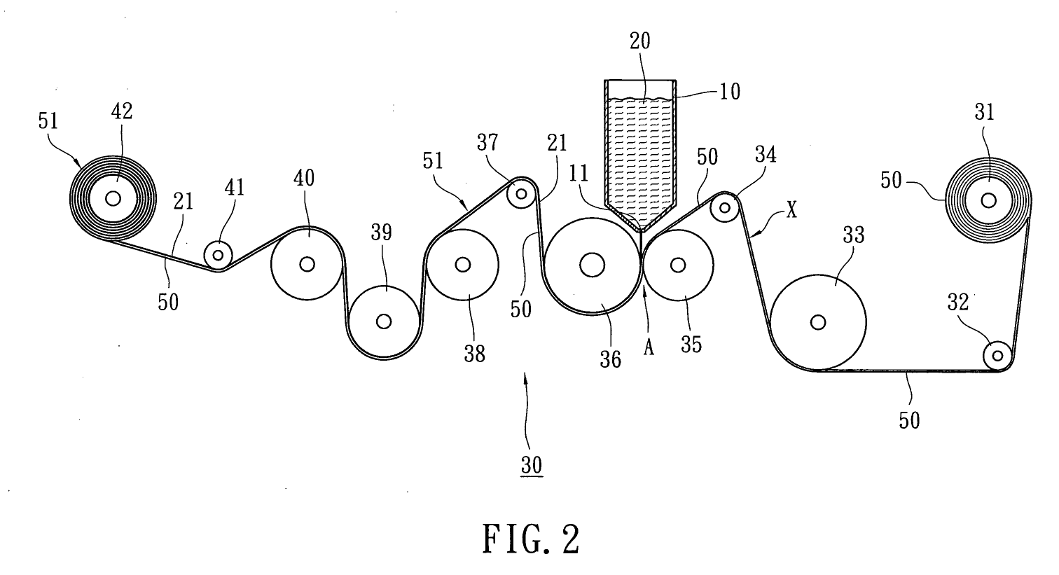

Referring to FIG. 1 and FIG. 2, a method of making a mat of the present invention coats continuously on substrate of foams, such as cross-linked polyolefin foam, EVA foam etc., wherein a T-die 10 is located above manufacturing equipment, and this T-die 10 can be exchanged, allowing a total length and a gap width of a discharge opening of a discharge tank 11 to be replaceable, to facilitate applying to an extrusion of different polymer substances of molten raw materials, for discharging the substrates upon continuously filming with a cladding material. Polymer substance of cladding material 20 is heated by an extruder screw at temperature of 150° C.˜250° C. to a flowing molten state, and a tank of the T-die 10 can be filled with the polymer substance of upper layer cladding material 20 for making the mat, and at a place a little lower to the T-die 10 is provided with a feeding wheel 31 belonging to a transporting device 30. A first turning idler 32 is pivoted below the feeding wheel 31, with a stretching wheel 33 being located at a side of the first turning idler 32. Then, each wheel is orderly installed to the transporting device 30, in accordance with a sequence of a second turning idler 34, a silicon rubber wheel 35, a knurling wheel 36, a third turning idler 37, a first rear-side cooling wheel 38, a front-side cooling wheel 39, a second rear-side cooling wheel 40, a fourth turning idler 41, and a collecting wheel 42.

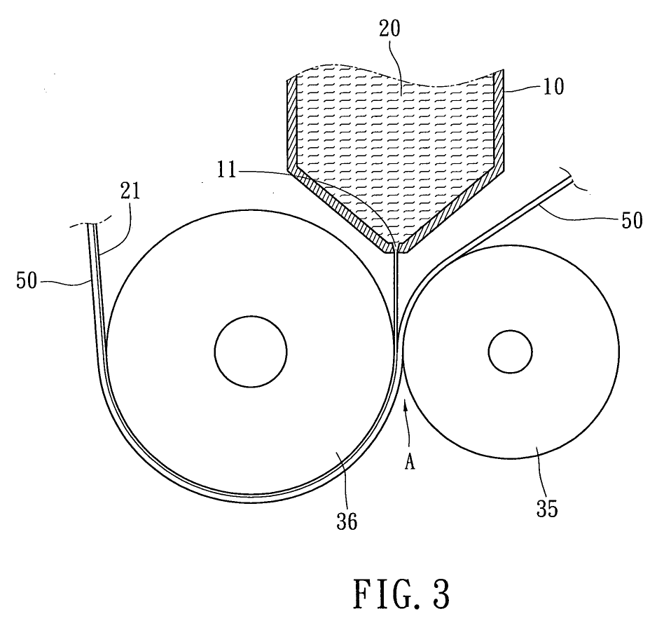

After the transporting device 30 is constructed, a roll of cross-linked polyolefin foam (CLPO foam for abbreviation) 50 is first wound on the feeding wheel 31 to serve as a base material for finishing. After being released by the feeding wheel 31, the CLPO foam 50 is wound on the stretching wheel 33, and is unrolled into a flat shape by the stretching wheel 33. Then, the CLPO foam 50 is wound on the second turning idler 34, followed by being transported to a slit A between the silicon rubber wheel 35 and the knurling wheel 36 (as shown in FIG. 3). A top surface X (upper layer) of the CLPO foam 50 is also an upper cladding material 21 of the mat which is formed by filming with the thick substance of upper layer cladding material 20 extruded from the discharge opening of the discharge tank 11 below the T-die 10. This upper cladding material 21 is preferably a molten thick substance of a thermoplastic rubber (or TPR for abbreviation); a molten polymer substance of a thermoplastic elastomer (or TPE for abbreviation); a molten thick substance of a thermoplastic plastic, such as a high density polyethylene (or HDPE for abbreviation), a low density polyethylene (or LDPE for abbreviation), a linear low density polyethylene (or LLDPE for abbreviation), and a polypropylene (or PP for abbreviation); or all kinds of synthetic resin (ethylene vinyl acetate, or EVA for abbreviation) for coating. For example, if the upper layer is filmed with TPE, then the mat will be provided with elastic and abrasive-proof properties; if the upper layer is filmed with HDPE, then the mat will be provided with toughness for withstanding an impact; if the upper layer is filmed with PP, then the mat will be provided with a heat-resistant property; whereas, if the upper layer is filmed with LDPE, then the mat will be provided with a smoother surface. In the embodiment as shown in the drawings, the upper layer is filmed with the polymer substance of TPR, and therefore, the mat will be slippery-proof and flexible.

Referring to FIG. 2, after the upper cladding material 21, which is filmed on the mat, is covered on the top surface (upper layer) of CLPO foam 50, they are joined together by the fact that the slit gap between the silicon rubber wheel 35 and the knurling wheel 36 is smaller than a total thickness of two layers of the raw material of the mat, and a complex material 51 formed by rolling consists of an upper layer which is the cladding material 21, and a lower layer which is CLPO foam 50. After the complex material 51 passes through the third turning idler 37, it is shaped by decreasing temperature, using the first rear-side cooling wheel 38, the front-side cooling wheel 39, and the second rear-side cooling wheel 40. Finally, after passing through the fourth turning idler 41, the complex material 51 is collected on the collecting wheel 42. As a wheel surface of the knurling wheel 36 can be carved with concaved and convex textures freely, patterns to be designed can be formed upon rolling the complex material 51.

The thickness of the aforementioned upper cladding material 21 for filming the mat can be determined by extrusion speed of the extruder screw and rotation speed of each wheel of the transporting device 30; that is, the quicker the speed of extruding raw material into the T-die 10 by the extruder screw is, the thicker of the cladding layer of the mat is; and the faster the rotation speed of each wheel of the transportation device 30, the thinner the cladding layer of the mat is. Therefore, the optimal thickness can be achieved and production efficiency can be increased, thereby controlling manufacturing cost. The thickness of the cladding layer of the present invention is preferably controlled to between 1 mm and 10 mm in a continuous production flow, and hence the quality of each mat produced is uniformly high.

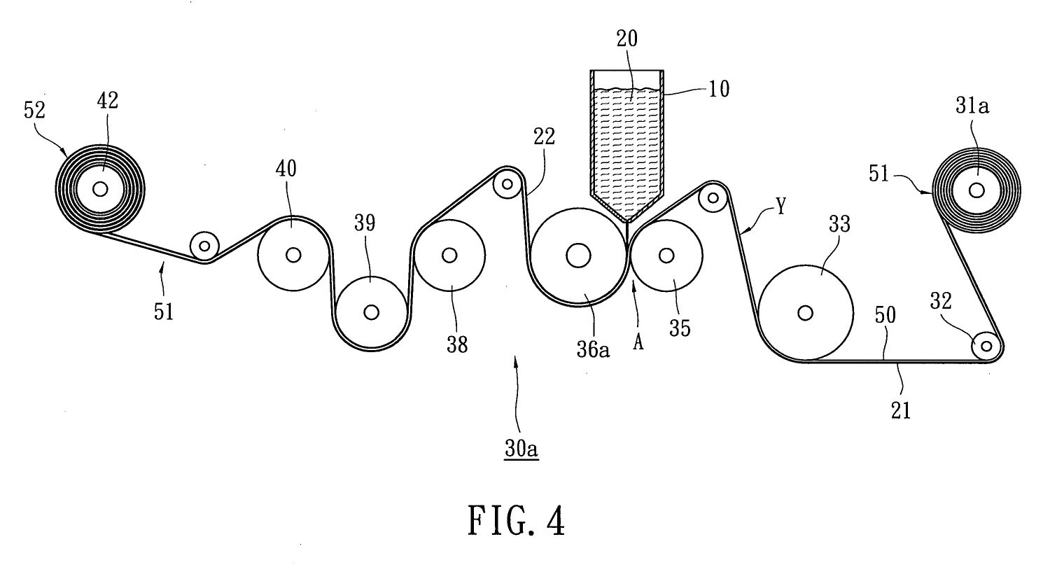

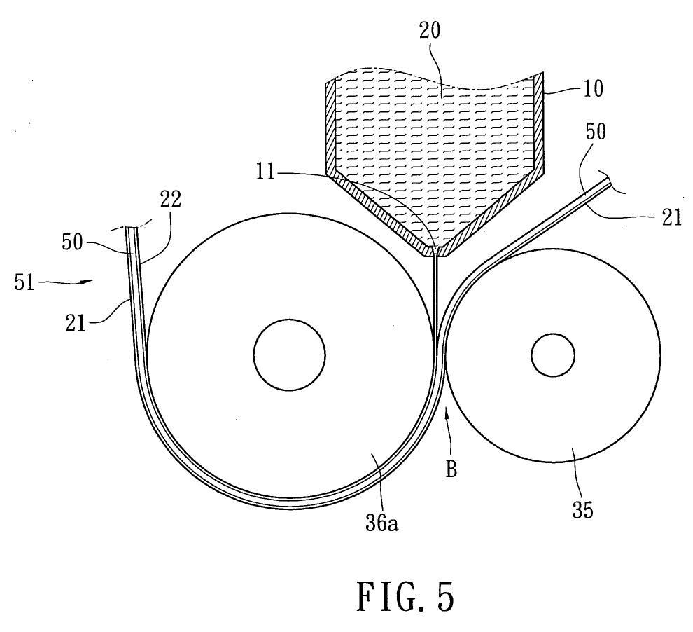

After accomplishing the aforementioned manufacturing process, a surface of the CLPO foam 50 can be filmed with the upper layer cladding material 21, and the aforementioned process has also disclosed that the upper layer cladding material 21 can be provided with many kinds of different abrasive-proof, slipper-proof, or flexible materials, such that the complex material 51 of the mat, which can be paved on a ground, can be manufactured. Referring to FIG. 4 and FIG. 5, if the complex material 51 needs to be more robust and to be in compliance with requirement of specific situation of utilization, then the complex material 51 can be once again emplaced on a feeding wheel 31a of another set of transporting device 30a, and by the same approach as the previous filming with the upper layer cladding material 21, the stretching wheel 33 is used again to smoothen the surface of the complex material 51, enabling a bottom surface Y (lower player) of the CLPO foam 50 to be joined with another lower layer cladding material 22, after the bottom surface has been filmed at a slit B between the silicon rubber wheel 35 and a knurling wheel 36a, followed by the same cooling procedure to be shaped into a mat 52 of a double-layer cladding.

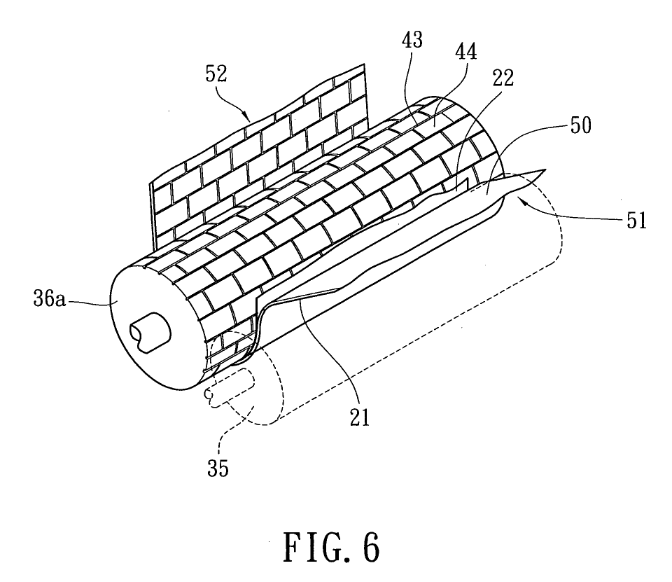

Referring to FIG. 6, as a wheel surface of the knurling wheel 36a of the transporting device 30a is provided with concaved grooves 43 and projected bumps 44, the surface of the mat can be finished into a lot of longitudinal and transversal grooves that are concaved downward. Therefore, the thick substance of lower layer cladding material 22 and the complex material 51, which are joined together between the silicon rubber wheel 35 and the knurling wheel 36a, are combined into the mat 52 of double-layer cladding, without using an adhesive.

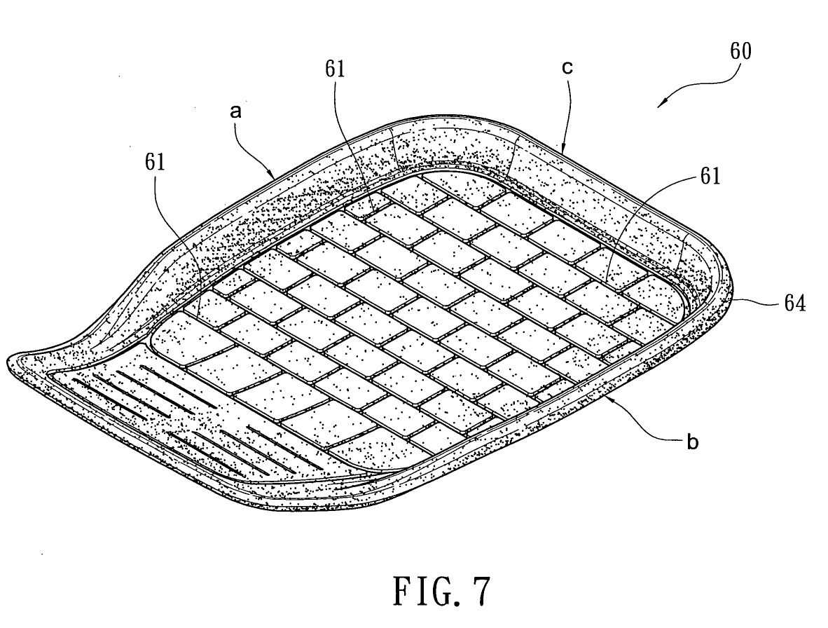

Referring to FIG. 7, on the mat which is made by filming, according to the manufacturing process of the present invention, the CLPO foam 50 in a middle layer is provided with a thicker board material, usually between 2 mm to 15 mm of thickness, enabling the entire mat to be thicker properly and to be more comfortable for applying to various situation. On the other hand, a covering slippery-proof liner, which is filmed on the lower layer, uses preferably a thin layer of TPR or a layer of TPE, such that each layer of surface material can be bonded without using the adhesive, and can be stably assembled into one body after being joined together by filming and rolling.

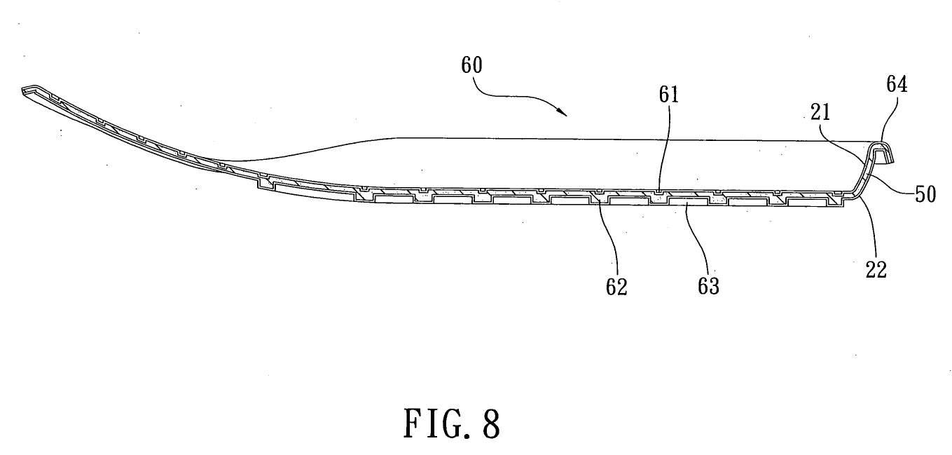

Referring to FIG. 7 and FIG. 8, the surface of the knurling wheel 36 or 36a can be also made into a non-smooth surface, and is emplaced into another molding tool (not shown in the drawings) to proceed with a joining and shaping, after finally trimming the mat. The molding tool used for joining is provided with concaved grooves and projected bumps on a board body, and therefore, an upper surface of an automobile mat 60 from finishing is formed with a plurality of longitudinal and transversal grooves 61 that are concaved downward, and a lower surface of the mat is formed with ridges 62 at places corresponding to the grooves 61. In addition, closed grooves 63 are formed between every ridge 62, and the grooves formed are in a closed shape, being surrounded by the ridges 62 at peripheries. Therefore, as a bottom surface of the automobile mat 60 is provided with the plurality of closed grooves 63, the mat 60 is provided with a buffering property. In addition, as the material itself is resistant to friction, the mat 60 will not slip freely. On the other hand, through an air exchange action performed when the upper closed grooves 63 are steppe down, the mat 60 is provided with an air-permeable effect. A left and a right side a, b, and a bottom side c of the automobile mat 60 (as shown in FIG. 7 and FIG. 8), are provided with protruded and reversely-folded rims 64, which allows a center of the mat to be provided with a concaved part for forming a three-dimensional space, thereby manufacturing into an automobile mat to be used on an in-car floor.

Accordingly, the manufacturing method of the present invention, whereby the single-layer or the double-layer of the mat is filmed with the cladding material and is then joined, to make the mat, can be used to manufacture the mat structure which is light in weight, slippery-proof, abrasive-proof, and flexible, and can be applied to making all kinds of products, including the automobile mats, slippery-proof mats, or sport mats, as well as can improve production efficiency.

Therefore, the present invention can indeed achieve the expected objects of invention, and provide a quick and effective method of making the mats with better functions with filming, without using any toxic adhesive for bonding materials of different layers, and thus being environmentally benign.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method of making a mat, wherein the mat includes a complex material of an upper layer and a lower layer, with the lower layer being a cross-linked polyolefin foam (or CLPO foam for abbreviation) or EVA foam, and manufacturing equipment being composed of a T-die of an extruder and a transporting device; the transporting device being located below the T-die, a tank of the T-die being filled with a molten polymer substance of a surface cladding material for making the upper layer of the mat, a silicon rubber wheel and a knurling wheel being located close to a discharge tank below the T-die, and the transporting device being provided with the CLPO foam or EVA foam for serving as a base material for finishing; the CLPO foam, which serves as the lower layer, being transported to a slit between the silicon rubber wheel and the knurling wheel to be filmed with the thick substance of upper cladding material; the CLPO foam or EVA foam and the polymer substance of upper cladding material being tightly combined into one body by joining between the silicon rubber wheel and the knurling wheel.

2. The method of making a mat according to claim 1, wherein the transporting device is provided with a plurality of roller elements including a feeding wheel, a first turning idler, a stretching wheel, a second turning idler, the silicon rubber wheel, the knurling wheel, a third turning idler, a first rear-side cooling wheel, a front-side cooling wheel, a second rear-side cooling wheel, a fourth turning wheel, and a collecting wheel.

3. The method of making a mat according to claim 1, wherein the upper layer molten polymer substance is chosen among the molten polymer substance of a thermoplastic rubber (or TPR for abbreviation); a thermoplastic elastomer (or TPE for abbreviation); a thermoplastic plastic, such as a high density polyethylene (or HDPE for abbreviation), a low density polyethylene (or LDPE for abbreviation), a linear low density polyethylene (or LLDPE for abbreviation), and a polypropylene (or PP for abbreviation); or all kinds of synthetic resin (ethylene vinyl acetate, or EVA for abbreviation) for coating.

4. A method of making a mat, wherein the mat includes a complex material formed with an upper layer, a middle layer, and a lower layer, with the middle layer being a cross-linked polyolefin foam (CLPO foam) or EVA foam, and manufacturing equipment being provided with a T-die of an extruder and a transporting device; the transporting device being located below the T-die, a tank of the T-die being filled with a molten thick substance of a surface cladding material for making the upper layer of the mat, a silicon rubber wheel and a knurling wheel being located close to a discharge tank below the T-die, and the transporting device being provided with the CLPO foam or EVA foam for serving as a base material for finishing; the CLPO foam or EVA foam, which serves as the middle layer, being transported to a slit between the silicon rubber wheel and the knurling wheel to be filmed with the thick substance of upper cladding material; the CLPO foam or EVA foam and the polymer substance of upper cladding material being tightly combined into one body by joining between the silicon rubber wheel and the knurling wheel, and the finished mat being once again filmed with a molten thick substance of a lower layer cladding material, followed by repeatedly joining the silicon rubber wheel and the knurling wheel.

5. The method of making a mat according to claim 4, wherein the transporting device is provided with a plurality of roller elements including a feeding wheel, a first turning idler, a stretching wheel, a second turning idler, the silicon rubber wheel, the knurling wheel, a third turning idler, a first rear-side cooling wheel, a front-side cooling wheel, a second rear-side cooling wheel, a fourth turning wheel, and a collecting wheel.

6. The method of making a mat according to claim 4, wherein the molten polymer substances of the upper and lower layers are chosen among the molten thick substance of a thermoplastic rubber (or TPR for abbreviation); a thermoplastic elastomer (or TPE for abbreviation); a thermoplastic plastic, such as a high density polyethylene (or HDPE for abbreviation), a low density polyethylene (or LDPE for abbreviation), a linear low density polyethylene (or LLDPE for abbreviation), and a polypropylene (or PP for abbreviation); or all kinds of synthetic resin (ethylene vinyl acetate, or EVA for abbreviation) for coating.
